(19) United States
(12) Patent Application Publication
(10) Pub. No.: US 2007/0081467 A1
(43) Pub. Date: Apr. 12, 2007

(54) Method and apparatus for testing a telecommunications network

(76) Inventors: Michael Hurst, Edinburgh (GB); Claudio Condini, London (GB); Hamish Butler, Perth (GB); Peter Mottishaw, Edinburgh (GB); John William Forsyth Macartney, Edinburgh (GB)

Correspondence Address: PERMAN & GREEN, 425 POST ROAD, FAIRFIELD, CT, 06824, US

(21) Appl. No.: 11/545,243

(22) Filed: Oct. 10, 2006

(30) Foreign Application Priority Data
Oct. 11, 2005 (GB) 05 20 633.9

(51) Int. Cl. H04J 3/14

(52) U.S. Cl. 370/248

(57) ABSTRACT

Apparatus and method for testing of a telecommunications network, which uses a passive monitoring system to generate actual customer usage data concerning the telecommunications network. An active test manager uses the actual customer usage data to instantiate a set of test templates from a store of predetermined test templates, the test template describing a sequence of user actions performed in the network. The test templates include at least one test variable, which is updated by the active test manager, using the actual customer usage data, to generate a test, or set of tests. The generated test, or set of tests are then used by an active testing module to actively test the telecommunications network, hence the tests are updated using the latest data on customer usage.

This invention relates to a method and apparatus for testing a telecommunications network.

### BACKGROUND ART

Communications Service Providers (CSPs) are challenged with managing the quality of the increasingly diverse set of services that they provide to their customers. A popular approach to monitoring quality is to simulate the behaviour of customers and measure the quality of service experienced by the simulated customers. This is frequently referred to as active testing. An alternative approach is to monitor actual customer behaviour using a passive monitoring system.

Passive monitoring is where a network “probe” is deployed to directly monitor customer behaviour. This has the potential to accurately monitor customer experience, but brings a number of disadvantages. One is that, by definition, passive testing cannot be proactive: issues can only be discovered “after the event”. Another reason is that measuring customer experience from passive monitoring can be very complex where multi-point measurements are required to measure quantities such as delay and packet loss. A further reason is that encryption can make it very difficult to measure some aspects of quality of service. Also, experience can only be measured up to the nearest point to the user of the service, for example, in general, problems cannot be captured that are due to user's handsets or terminals.

Active testing, described above, also has disadvantages; for example, the active tests are preconfigured by technicians who may have no idea of the way in which the customer uses the services. Also, the active tests do not adapt to changing customer behaviour and so may no longer reflect the actual customer experience, even if they were configured correctly in the first place. Active tests may be using network resources to test aspects of services that are only rarely used by customers, thus wasting resources. These issues can be partly addressed by regularly updating the set of tests run, but this requires continuous manual intervention and is therefore both costly and error-prone.

### DISCLOSURE OF THE INVENTION

According to one aspect of this invention there is provided a system for testing a telecommunications network, the system comprising a monitoring system, for coupling to the telecommunications network, for collecting data concerning actual customer usage of the telecommunications network, a test template manager coupled to the monitoring system for receiving the actual customer usage data and for using the actual customer usage data to choose at least one test template from a set of pre-determined test templates, the at least one test template further comprising at least one test variable; wherein the test template manager updates the at least one test variable using the received actual customer usage data to generate at least one test, and a testing module for coupling to the telecommunications network, wherein the testing module is coupled to the test template manager and receives the at least one test for execution on the telecommunications network for generating at least one test result.

The telecommunications network may be a packet-switched telecommunications network, which in turn may be either an IP or a MPLS network.

The telecommunications network may be a mobile telephony network, which may be a GSM, UMTS, CDMA or a GPRS network.

The telecommunications network may an ATM Network.

The system may further comprise a display for displaying the at least one test variable, the at least one test template, and the at least one test result.

The system may further comprise a storage device for storing the at least one test variable, the at least one test template, and the at least one test result.

The system may be implemented on a machine with a Unix Operating System, which in turn may be a Linux, HP-UX, or Solaris operating system; or on a machine with a Windows XP or Windows NT operating system.

According to a second aspect, the invention provides a method of testing a telecommunications network, the method comprising collecting data concerning actual customer usage of the telecommunications network, using the actual customer usage data to choose at least one test template from a set of pre-determined test templates, the at least one test template further comprising at least one test variable, updating the at least one test variable using the received actual customer usage data to generate at least one test, executing the at least one test on the telecommunications network, and generating at least one test result.

The method may further comprise receiving user configurations.

The method may further comprise displaying the at least one test variable, the at least one test template and the at least one test result.

The method may further comprise storing the at least one test variable, the at least one test template and the at least one test result.

### BRIEF DESCRIPTION OF DRAWINGS

A method and apparatus in accordance with one embodiment of the present invention for testing a telecommunications network, will now be described, by way of example, with reference to the accompanying drawings, in which:

FIG. 1 is a diagram showing an overview of a passive monitoring system, as known in the art;

FIG. 2 is an diagram showing an overview of a network test system, according to one embodiment of the present invention; and

FIG. 3 is a flow chart describing the operation of the network test system of FIG. 2.

### DETAILED DESCRIPTION

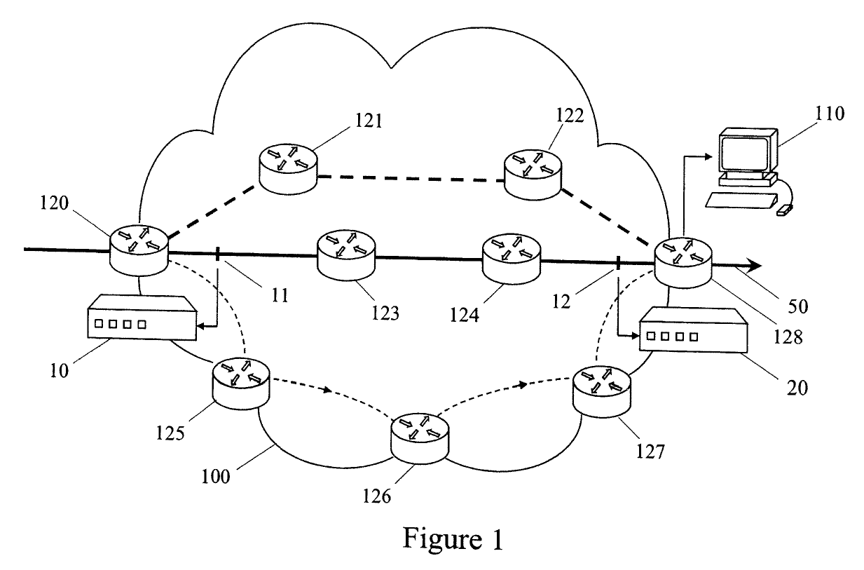

FIG. 1 is a diagram showing an overview of a passive monitoring system, as known in the art. There is shown a packet switched telecommunications network 100, which comprises router nodes 120, 121, 122, 123, 124, 124, 125, 126, 127, 128, a network management station (NMS) 110, as well as two passive monitoring probes 10, 20 which perform measurements and send these measurements to the NMS 110.

Under observation is a single link 50, which passes through router node 120, 123, 124 and 128. The NMS 110 collects and also may store the results from the two probes 10, 20 and in this example the NMS 110 is connected to the router node 128.

The two probes 10, 20 use taps 11, 12 to connect into the link 50 under observation, which are typically located at the ingress and egress router nodes 120, 128 for the link 50. The probes 10, 20 are passively monitoring the packets that are going by.

In this example, for simplicity, there is a single NMS 110 in the packet switched telecommunications network 100, although any person skilled in the art will appreciate that there could be more. The NMS 110 may also be remote from both probes 10, 20, requiring the establishment of further links from both probes 10, 20. Furthermore, other probes may be being used in the MPLS network 100 at the same time.

To calculate, for example, parameters such as delay and loss measures for data traffic for SLA purposes crossing the packet switched telecommunications network 100, normally requires measurements at two-points, as shown. The properties of packets being monitored need to be identified and measured at an ingress router 120 and then these same packets need to be analyzed as they pass through the egress router 128.

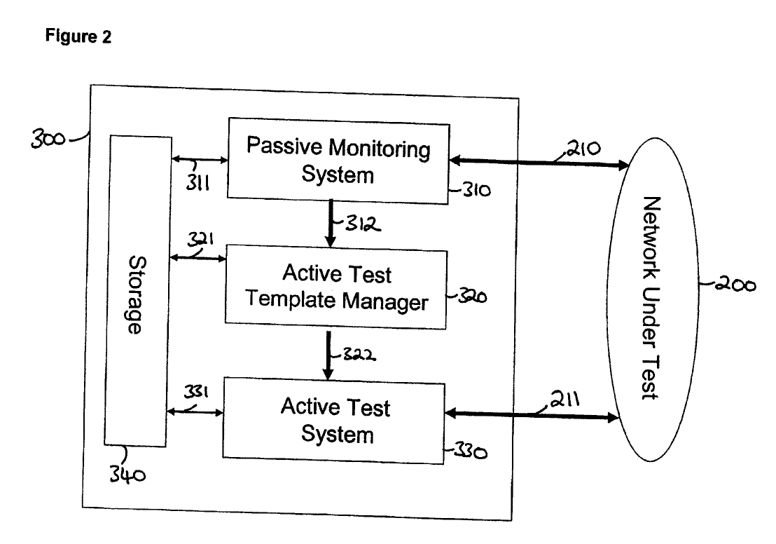

FIG. 2 is a diagram showing an overview of a network test system according to one embodiment of the present invention. In FIG. 2 there is shown a network test system 300, which comprises a passive monitoring system 310 (such as that described previously with reference to FIG. 1), an active test template manager 320, an active test system 330, as well as storage 340.

The passive monitoring system 310 is coupled to a network under test 200, via two-way link 210, and by passively monitoring the network under test 200 provides, via link 312, data concerning the actual customer usage of the network under test 200, to the active test template manager 320. The passive monitoring system 310 can also store the customer usage data in the storage 340 and is coupled to the storage 340 via two-way link 311.

The active test template manager 320 uses the received customer usage data to update, via two-way link 321, a set of pre-determined active test templates which are stored in the storage 340. The pre-determined active test templates are related to the type, or sequence of actions the user performs in the telecommunications network being monitored, in this case the network under test 200. It may be that the sequence of network services used by a customer has a certain pattern, for example, a user may always open the calendar in Outlook immediately after logging onto the Internet. These sequences are used to derive the active test templates. An example of an active test template may be “select URL <X>; download page <Y>”. The values of the variables “X” and “Y” are captured by the passive monitoring system 310. In the previous example, the actual address (or location) of the calendar on the user's computer or network, would be captured as an active test variable.

Examples of telecommunications networks that may be tested using the network test system 300 are mobile telephony networks, such as a GSM (Global System for Mobile Communications), UMTS (Universal Mobile Telephony Service), CDMA (Code Division Multiple Access), or a GPRS (General Packet Radio System) network, or data networks, such as the Internet, that use technologies such as ATM (Asynchronous Transfer Mode), IP (Internet Protocol), or MPLS. The specific telephone numbers used by voice users in a GSM network, or the URLs (Uniform Resource Locators) used by users of the Internet may be captured as active test variables called “telephone number”, or “URL”.

In general the format of the active test templates may also depend on the objectives of the test itself: different groups of testers will have different priorities. For example if a tester is interested in getting most of the customers satisfied most of the time then the baseline, ie normal operating conditions will probably be primarily tested; if a tester is interested in making sure a new software patch on a router in the network has been successful, then the boundary conditions, ie abnormal behaviour of the router, may be tested instead. These options could be configured externally by a user.

An active test is the result of an active test template updated with required values for the active test variables. One reason to update the pre-determined active test templates is to make the resulting tests more meaningful, for example it may be found that most of the customers belonging to a very important segment access “www.itv.com” rather than “www.bbc.co.uk”, making the former the best candidate for an active test.

The active test template manager 320 generates a set of active tests by updating the whole of, or a subset of the store of pre-determined active test templates with the required values for the active test variables. The active test system 330, which is coupled to the active test template manager 330 via link 322, receives the set of active tests from the active test template manager 320 and uses them to simulate customer behaviour whilst testing the network under test 200, via two-way link 211. The active test system 330 also generates the test results from the network under test 200 and stores the test results in the storage 340 via two-way link 331.

The storage 340 is used to store the active test templates, active test variables, active tests, as well as the test results and may be implemented as a database, although it should be clear to someone skilled in the art that the storage 240 may implemented by other means.

The network test system 300 could be implemented on a machine with a Unix Operating System, which in turn may be a Linux, HP-UX, or Solaris operating system; or on a machine with a Windows XP or Windows NT operating system, but it will be obvious to someone skilled in the art that it could be implemented on any other suitable Operating System and in any other suitable manner. It should also be obvious to someone skilled in the art that the active test templates, current set of active tests as well as the test results could also be displayed on a GUI (Graphical User Interface).

The network test system 300 uses active testing to emulate customer experience, but overcomes the problems of the prior art by continuously adapting the active tests to more accurately reflect real customer behaviour. The customer usage data can be collected from a number of sources, but in this particular embodiment the passive monitoring system 310 is used as a source of unbiased information. By monitoring the actual behaviour of customers, the active tests can be focused on the very same services and usage patterns that they use, thus ensuring that the simulated test accurately models the behaviour of real customers.

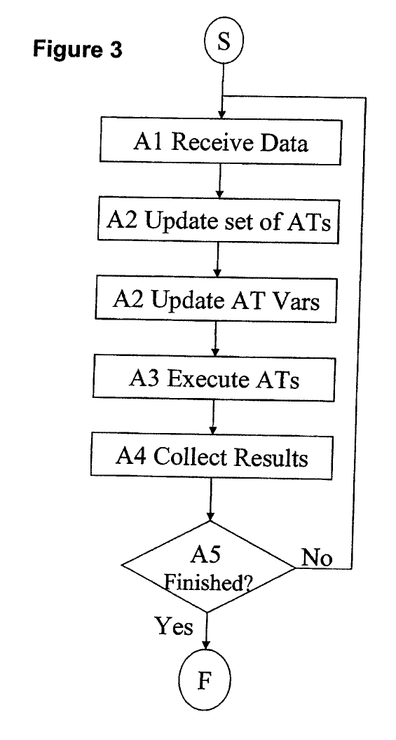

The operation of the network test system 300 is described in more detail with reference to FIG. 3 following.

FIG. 3 is a flow chart describing the operation of the network test system of FIG. 2. The flow chart is described in more detail following, the operation of the network test system starts at “S” and finishes at “F”.
A1: Receive Data. Customer usage data is continuously received from a passive monitoring system.
   Got to A2
A2: Update set of ATs. A set of active test templates is chosen from a store of predetermined active test templates, depending on the received customer usage data. For example, if customers are no longer using a particular service, the tests corresponding to that service are removed from the current set of active test templates.
   Go to A3
A3: Update AT Vars. Update active test variables. The active test variables in each active test template in the current set (as determined by A2) are updated with new values, if they have changed. Thus for example when executing a simulated web access from an active tester, the URL being used could be one of the most popular ones, or one of those for which a disproportionate amount of errors has occurred.
   Go to A4
A4: Execute ATs. Active tests are executed in line with the current set of active test templates updated with the appropriate active test variables (as performed in A3).
   Go to A5
A5: Collect Results. Results of the active tests currently being performed are generated by the network test system and are stored, possibly in a database for example.
   Go to A6
A6: Finished? The operation of the network test system is terminated if finished.
   If Yes, go to F.
   If No, go to A1

The network test system, as described, improves the effectiveness and efficiency of active testing by using data collected from passive monitoring. This enables active tests to adapt to reflect actual customer behaviour in real time. It also enables active tests to be eliminated which do not reflect actual customer behaviour.

It will be appreciated that although only one particular embodiment of the invention has been described in detail, various modifications and improvements can be made by a person skilled in the art without departing from the scope of the present invention.

1. A system for testing a telecommunications network, the system comprising:
a monitoring system, for coupling to the telecommunications network, for collecting data concerning actual customer usage of the telecommunications network;
a test template manager coupled to the monitoring system for receiving the actual customer usage data and for using the actual customer usage data to choose at least one test template from a set of pre-determined test templates, the at least one test template further comprising at least one test variable; wherein the test template manager updates the at least one test variable using the received actual customer usage data to generate at least one test; and
a testing module for coupling to the telecommunications network, wherein the testing module is coupled to the test template manager and receives the at least one test for execution on the telecommunications network for generating at least one test result.

2. A system according to claim 1, wherein the telecommunications network is a packet-switched telecommunications network.

3. A system according to claim 2, wherein the packet-switched telecommunications network is either an IP or a MPLS network.

4. A system according to claim 2, wherein the telecommunications network is a mobile telephony network.

5. A system according to claim 4, wherein the mobile telephony network is a GSM, GPRS, CDMA or UMTS network.

6. A system according to claim 1, wherein the telecommunications network is an ATM Network.

7. A system according to claim 1, further comprising a display for displaying the at least one test variable, the at least one test template, and the at least one test result.

8. A system according to claim 1, further comprising a storage device for storing the at least one test variable, the at least one test template, and the at least one test result.

9. A system according to claim 1, wherein the system is implemented on a machine with a Linux, HP-UX, Solaris, Windows XP or Windows NT operating system.

10. A method of testing a telecommunications network, the method comprising:
collecting data concerning actual customer usage of the telecommunications network;
using the actual customer usage data to choose at least one test template from a set of pre-determined test templates, the at least one test template further comprising at least one test variable;
updating the at least one test variable using the received actual customer usage data to generate at least one test;
executing the at least one test on the telecommunications network; and
generating at least one test result.

11. A method according to claim 10, further comprising receiving user configurations.

12. A method according to claim 10, further comprising displaying the at least one test variable, the at least one test template and the at least one test result.

13. A method according to claim 10, further comprising storing the at least one test variable, the at least one test template and the at least one test result.
